(19) United States
(12) Patent Application Publication
(10) Pub. No.: US 2008/0018224 A1
(43) Pub. Date: Jan. 24, 2008

(54) IMAGE DISPLAY DEVICE

(76) Inventors: Satoshi Ishikawa, Fukaya-shi (JP); Sachiko Hirahara, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/689,892

(22) Filed: Mar. 22, 2007

Related U.S. Application Data
(63) Continuation of application No. PCT/JP05/17629, filed on Sep. 26, 2005.

(30) Foreign Application Priority Data
Sep. 27, 2004 (JP) 2004-280204

(51) Int. Cl. H01J 1/62

(52) U.S. Cl. 313/495

(57) ABSTRACT

An envelope of an image display device has a first substrate formed with a phosphor screen including a phosphor layer and a second substrate opposed to the first substrate across a gap and provided with a plurality of electron emission sources which excite the phosphor layer. A plurality of columnar spacers which support an atmospheric load acting on the first and second substrates are provided between the first substrate and the second substrate. The plurality of spacers are individually bonded on the first substrate with an adhesive having an electrical resistance not higher than the electrical resistance of the spacers and set up on the first substrate.

### CROSS-REFERENCE TO RELATED APPLICATIONS

This is a Continuation Application of PCT application No. PCT/JP2005/017629, filed Sep. 26, 2005, which was published under PCT Article 21(2) in Japanese.

This application is based upon and claims the benefit of priority from prior Japanese Patent Application No. 2004-280204, filed Sep. 27, 2004, the entire contents of which are incorporated herein by reference.

### BACKGROUND OF THE INVENTION

1. Field of the Invention

This invention relates to an image display device provided with substrates opposed to each other and spacers located between the substrates.

2. Description of the Related Art

In recent years, various flat image display devices have been noticed as a next generation of lightweight, thin display devices to replace cathode-ray tubes (CRTs). For example, a surface-conduction electron emission device (SED) has been developed as a kind of a field emission device (FED).

This SED comprises a first substrate and a second substrate that are opposed to each other with a predetermined space between them. These substrates have their respective peripheral portions joined together by a rectangular sidewall, thereby constituting a vacuum envelope. Three-color phosphor layers and a metal back layer are formed on the inner surface of the first substrate. Arranged on the inner surface of the second substrate are a large number of electron emitting elements for use as electron sources, which correspond to pixels, individually, and excite the phosphors. Each electron emitting element is composed of an electron emitting portion, a pair of electrodes that apply voltage to the electron emitting portion, etc.

For the SED described above, it is important to maintain a high degree of vacuum of about 10⁻⁴ Pa in the space between the first substrate and the second substrate, that is, in the vacuum envelope. If the degree of vacuum is low, the life of the electron emitting elements, and hence, the life of the device shorten inevitably. Since a vacuum is maintained between the first substrate and the second substrate, moreover, atmospheric pressure acts on the first substrate and the second substrate. In order to support the atmospheric load that acts on these substrates and maintain the gap between the substrates, therefore, a large number of plate-shaped or columnar spacers are located between the two substrates.

In order to locate the spacers to cover the first substrate and the second substrate entirely, spacers in the form of very thin plates or very slender columns should be used lest they touch the phosphors on the first substrate and the electron emitting elements on the second substrate. Since these spacers must be set very close to the electron emitting elements, an insulating material should preferably be used for the spacers. At the same time, more spacers are needed in order to make the first substrate and the second substrate thinner. Proposed in, for example, Jpn. Pat. Appln. KOKAI Publication No. 2001-272927, is a method in which a large number of spacers are formed with high positional accuracy on a metal plate that is previously formed with apertures through which electron beams pass and the spacers formed on the metal plate are located between a first substrate and a second substrate.

In displaying an image on the SED, an anode voltage is applied to the phosphor layers, and electron beams emitted from the electron emitting elements are accelerated by the anode voltage and collided with the phosphor layers. Thereupon, the phosphors glow and display the image. In order to obtain practical display characteristics, the anode voltage should be set to several kV or more, and preferably to 5 kV or more, with use of phosphors similar to those of a conventional cathode-ray tube.

With the above configuration in which the spacers are set up on a supporting substrate, the spacers are subjected to a load that is attributable to a difference in thermal expansion between the first and second substrates and the supporting substrate in the process of manufacture or the like, so that the spacers may possibly be damaged. When electrons with high acceleration voltage collide with the phosphor screen, in the SED, moreover, secondary electrons and reflected electrons develop on the phosphor screen. If the space between the first substrate and the second substrate is narrow, the secondary electrons and the reflection electrons that are generated on the phosphor screen collide with the spacers, whereupon the spacers are electrified. Normally, the spacers are positively charged with the acceleration voltage in the SED. In this case, the electron beams emitted from the electron emitting elements are attracted to the spacers and inevitably deviated from their original orbits. In consequence, the electron beams misland on the phosphor layers, thereby lowering the color purity of displayed images.

If the spacers are electrified, furthermore, electric discharge easily occurs near the spacers. If the spacer surface is coated with a low-resistance film in order to control the movement of the electron beams, in particular, electric discharge from the spacers occurs more easily. In this case, there is a possibility of the withstand voltage characteristics lowering.

### BRIEF SUMMARY OF THE INVENTION

This invention has been made in consideration of these circumstances, and it provides an image display device with improved withstand voltage characteristics and reliability, in which spacers can be restrained from being damaged or electrified.

According to an aspect of the invention, there is provided an image display device comprising: a first substrate formed with a phosphor screen including phosphor layers; a second substrate opposed to the first substrate across a gap and provided with a plurality of electron emission sources which excite the phosphor layers; a plurality of columnar spacers which are arranged between the first substrate and the second substrate and support an atmospheric load acting on the first and second substrates,

the plurality of spacers being individually bonded on the first substrate or the second substrate with an adhesive having an electrical resistance not higher than an electrical resistance of the spacers and set up on one of the substrates.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an SED according to a first embodiment of this invention;

FIG. 2 is a perspective view of the SED broken away along line II-II of FIG. 1;

FIG. 3 is a sectional view enlargedly showing the SED;

FIG. 4 is a plan view showing a first substrate of the SED;

FIG. 5 is a sectional view enlargedly showing an SED according to a second embodiment of this invention; and

FIG. 6 is a sectional view enlargedly showing an SED according to a third embodiment of this invention.

### DETAILED DESCRIPTION OF THE INVENTION

An embodiment in which this invention is applied to an SED as a flat image display device will now be described in detail with reference to the drawings.

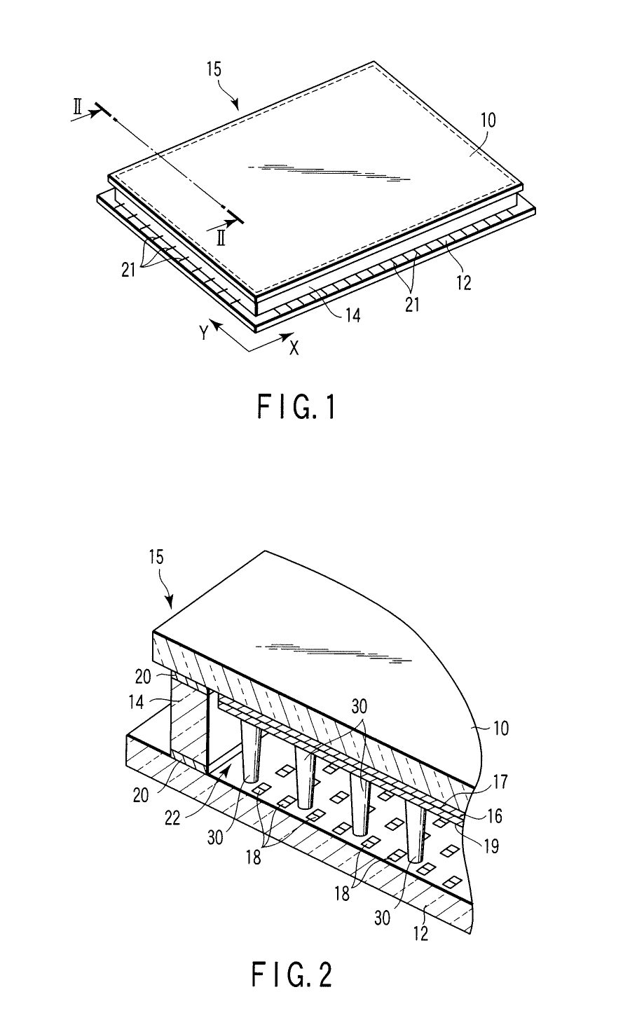

As shown in FIGS. 1 to 3, the SED comprises a first substrate 10 and a second substrate 12, which are formed of a rectangular glass plate each. These substrates are opposed to each other with a gap of about 1.0 to 2.0 mm between them. The first substrate 10 and the second substrate 12 have their respective peripheral edge portions joined together by a sidewall 14 in the form of a rectangular frame of glass, thereby constituting a flat rectangular vacuum envelope 15 of which the inside is kept at a high vacuum of about 10⁻⁴ Pa or less. The sidewall 14 that functions as a joint member is sealed to the peripheral edge portion of the first substrate 10 and the peripheral edge portion of the second substrate 12 with a sealant 20 of, for example, low-melting-point glass or low-melting-point metal, whereby these substrates are joined together.

A phosphor screen 16 that functions as a phosphor surface is formed on the inner surface of the first substrate 10. The phosphor screen 16 has phosphor layers R, G and B, which glow red, green, and blue, respectively, and a matrix-shaped light shielding layer 11. A metal back 17 consisting mainly of, for example, aluminum is formed on the phosphor screen 16, and moreover, a getter film 19 is formed overlapping the metal back.

Provided on the inner surface of the second substrate 12 are a large number of surface-conduction electron emitting elements 18 for use as electron sources, which individually emit electron beams and excite the phosphor layers R, G and B of the phosphor screen 16. These electron emitting elements 18 are arrayed in a plurality of columns and a plurality of rows corresponding to pixels. Each electron emitting element 18 is formed of an electron emitting portion (not shown), a pair of element electrodes that apply voltage to the electron emitting portion, etc. A large number of wires 21 that drive the electron emitting elements 18 are provided in a matrix on the inner surface of the second substrate 12, and their respective end portions are led out of the vacuum envelope 15.

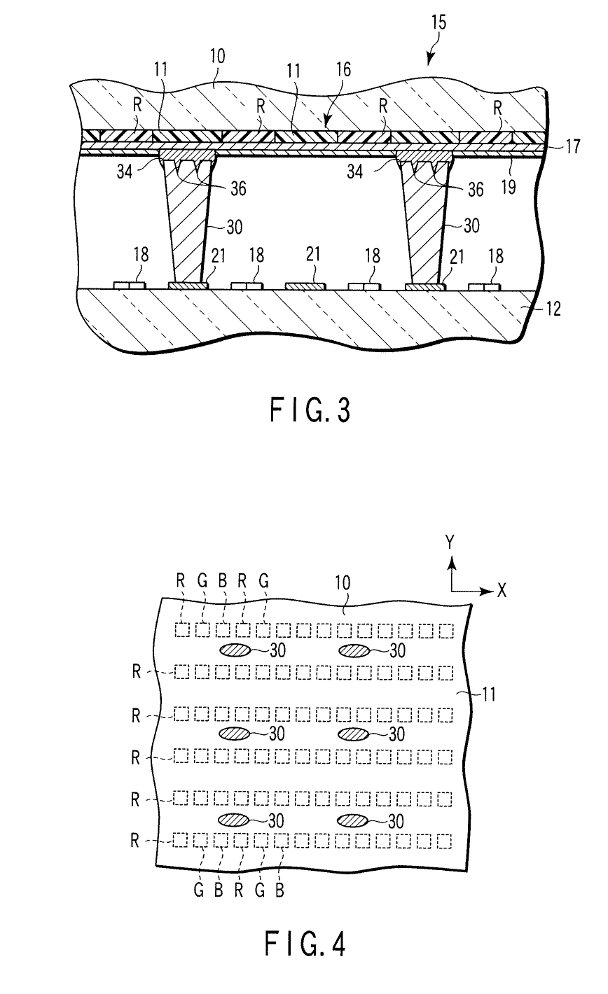

In the phosphor screen 16 provided on the inner surface of the first substrate 10, as shown in FIGS. 3 and 4, the phosphor layers R, G and B are formed having a rectangular shape each. If the longitudinal direction of the first substrate 10 and the transverse direction perpendicular thereto are a first direction X and a second direction Y, respectively, the phosphor layers R, G and B are alternately arrayed with predetermined gaps in the first direction X between them, and the phosphor layers of the same color are arrayed with predetermined gaps in the second direction between them. The phosphor layers R, G and B are situated individually opposite their corresponding electron emitting elements 18. The phosphor screen 16 has the light shielding layer 11 that is black. This light shielding layer has a rectangular frame portion that extends along the peripheral edge portion of the first substrate 10 and a matrix portion that extends in a matrix between the phosphor layers R, G and B inside the rectangular frame portion.

As shown in FIGS. 2 to 4, the SED comprises a large number of spacers 30 that are located between the first substrate 10 and the second substrate 12. These spacers 30 are columnar and set up integrally on the inner surface of the first substrate 10. Specifically, the spacers 30 are formed by firing and vitrifying a spacer forming material as an insulating material that consists mainly of glass, and their respective one ends are bonded on the surface of the first substrate 10 with an adhesive 34. In the present embodiment, each spacer 30 is fixed on the metal back 17 and set up in a position corresponding to the light shielding layer 11 between the phosphor layers that adjoin in the second direction Y.

A plurality of grooves 36 are formed in the end face of each spacer 30 on the first substrate 10 side in order to increase the area of contact with the adhesive 34. The adhesive 34 used is an adhesive that has an electrical resistance not higher than the electrical resistance of the spacers 30 and consists mainly of glass, e.g., electrically conductive fritted glass. The softening point of a glass component of the adhesive 34 is set to be lower than the softening point of a glass component of the spacers 30. Further, the thermal expansion coefficient of the adhesive 34 is set so that its difference from the thermal expansion coefficient of the first substrate 10 is within ±20%. Besides the fritted glass, a metal paste or the like may be used for the adhesive 34.

The respective extended ends of the spacers 30 abut on the inner surface of the second substrate 12, that is, on the wires 21 provided on the inner surface of the second substrate 12 in this case. Each of the spacers 30 is tapered so that its diameter is reduced from its proximal end on the first substrate 10 side toward its extended end. The cross section of each spacer 30 along a direction parallel to the inner surface of the first substrate 10 is substantially elliptic. Differences in height between the plurality of spacers 30, that is, dispersion in height is restricted within the range of 1 to 50 μm.

The respective extended ends of the plurality of spacers 30 that are set up on the first substrate 10 abut on the inner surface of the second substrate 12, thereby supporting an atmospheric load that acts on the first and second substrates and keeping the space between the substrates at a predetermined value.

In displaying an image on the SED, an anode voltage of, for example, 8 kV is applied to the phosphor screen 16 and the metal back 17, and the electron beams emitted from the electron emitting elements 18 are accelerated by the anode voltage and collided with the phosphor screen. Thereupon, the corresponding phosphor layers R, G and B of the phosphor screen 16 are excited to luminescence and display the image.

The following is a description of a method of manufacturing the SED constructed in this manner. A manufacturing method for the first substrate 10 and the spacers 30 will be described first.

First, the plurality of spacers 30 are simultaneously formed with use of a molding die that has a plurality of spacer forming holes. Initially, a spacer forming material 46 is loaded into the spacer forming holes of the molding die. A glass paste that contains an ultraviolet-curing binder (organic component) and a glass filler is used as the spacer forming material 46. The specific gravity and viscosity of the glass paste are selected as required. Then, ultraviolet (UV) rays are applied to the loaded spacer forming material 46 to UV-cure the spacer forming material. After the cured spacer forming material is released from the die, it is heat-treated in a heating furnace so that the binder is evaporated from the spacer forming material. Further, the spacer forming material is regularly fired and vitrified at about 500 to 550° C. for 30 minutes to 1 hour. Thereupon, the plurality of spacers 30 are obtained.

Subsequently, the plurality of spacers 30 are held by means of a jig or the like, and the adhesive 34 is spread on one end face of each spacer. Then, the respective one ends of the spacers 30 are bonded on the metal back 17 of the first substrate 10 with the adhesive 34. Thereafter, the spacers 30 are fixed and set up in predetermined positions on the first substrate by curing the adhesive 34.

In the manufacture of the SED, on the other hand, the second substrate 12, which is provided with the electron emitting elements 18 and the wires 21 and to which the sidewall 14 is joined, is manufactured separately. Subsequently, after a mask, e.g., a plate-shaped metal mask, is located so as to cover the respective extended ends of the spacers 30, the first substrate 10 and the second substrate 12 are located in a vacuum chamber, and the vacuum chamber is exhausted to a vacuum.

The getter film 19 is formed by evaporating the getter lapped on the metal back 17 of the first substrate 10 in a vacuum atmosphere. Since the spacers 30 are covered by the mask, as this is done, the getter film 19 can be formed without soiling the spacers. After the getter film 19 is formed, the mask 52 is removed from the spacers 30. Thereafter, the first substrate 10 and the second substrate 12 are joined together with the aid of the sidewall 14 in a vacuum atmosphere. Thereupon, the SED with the spacers 30 is obtained.

According to the SED constructed in this manner, the spacers 30 are independently fixed to the first substrate 10. If the first and second substrates 10 and 12 are thermally expanded during a manufacturing process or the like, therefore, a load that acts on the spacers can be reduced to prevent the spacers from being damaged. Since the thermal expansion coefficient of the adhesive 34 is set so that its difference from the thermal expansion coefficient of the first substrate 10 is within ±20%, the adhesive 34 can be prevented from being separated by the difference in thermal expansion.

Since the electrical resistance of the adhesive 34 with which the spacers 30 are bonded is set to be not higher than the electrical resistance of the spacers 30, electric charge on the spacers can be discharged to the first substrate 10, so that the spacers can be restrained from being electrified. Thus, deorbiting of electron beams that is attributable to electrification of the spacers 30 can be suppressed, so that an image with improved display quality can be displayed. At the same time, the SED can be obtained ensuring improved withstand voltage characteristics and reliability.

If the plurality of spacers 30 are subject to any dispersion in height, the adhesive 34 can absorb this dispersion in height. Accordingly, gaps can be prevented from being formed between the spacers 30 and the second substrate 12, so that the plurality of spacers can stably support the first and second substrates 10 and 12, and generation of a strong electric field attributable to the gaps can be prevented.

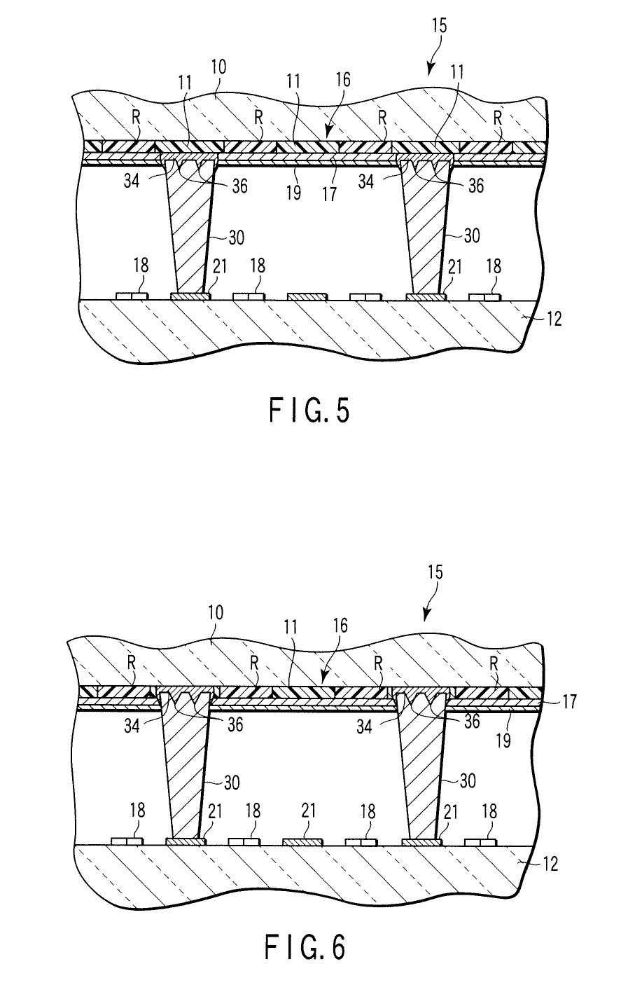

The following is a description of an SED according to a second embodiment of this invention. As shown in FIG. 5, the SED comprises a large number of spacers 30 that are located between a first substrate 10 and a second substrate 12. According to the present embodiment, the spacers 30 are bonded and set up integrally on a phosphor screen 16 of the first substrate 10 with an adhesive 34. The spacers 30 are formed by firing and vitrifying a spacer forming material as an insulating material that consists mainly of glass, and their respective one ends are fixed to a light shielding layer 11 of the phosphor screen 16. The respective extended ends of the spacers 3 abut on wires 21 provided on the inner surface of the second substrate 12. Each of the spacers 30 is tapered so that its diameter is reduced from its proximal end on the first substrate 10 side toward its extended end. The cross section of each spacer 30 along a direction parallel to the inner surface of the first substrate 10 is substantially elliptic.

Other configurations of the SED are the same as those of the foregoing first embodiment, so that like reference numerals are used to designate like portions, and a detailed description thereof is omitted.

As shown in FIG. 6, an SED according to a third embodiment of this invention comprises a large number of spacers 30 that are located between a first substrate 10 and a second substrate 12. According to the present embodiment, the spacers 30 are set up integrally on the first substrate in a manner such that their respective one ends are bonded directly on the inner surface of the first substrate 10 with an adhesive 34. The spacers 30 are formed by firing and vitrifying a spacer forming material as an insulating material that consists mainly of glass. The respective extended ends of the spacers 3 abut on wires 21 provided on the inner surface of the second substrate 12. Each of the spacers 30 is tapered so that its diameter is reduced from its proximal end on the first substrate 10 side toward its extended end. The cross section of each spacer 30 along a direction parallel to the inner surface of the first substrate 10 is substantially elliptic.

Other configurations of the SED are the same as those of the foregoing first embodiment, so that like reference numerals are used to designate like portions, and a detailed description thereof is omitted.

The same functions and effects of the first embodiment can be also obtained from the SEDs according to the second and third embodiments arranged in the aforementioned manner.

The present invention is not limited directly to the embodiments described above, and its components may be embodied in modified forms without departing from the spirit of the invention. Further, various inventions may be formed by suitably combining a plurality of components described in connection with the foregoing embodiments. For example, some of the components according to the embodiments may be omitted. Furthermore, components according to different embodiments may be combined as required.

Although the spacers are fixed to the first substrate with the adhesive in the embodiments described above, they may alternatively be bonded on the second substrate with the adhesive. The shapes, materials, etc. of the spacers and the other components are not limited to the foregoing embodiments, but may be suitably selected as required. This invention is not limited to image display devices that use surface-conduction electron emitting elements as electron sources, but may be also applied to image display devices that use other electron sources, such as the field-emission type, carbon nanotubes, etc.

What is claimed is:

1. An image display device comprising:
a first substrate formed with a phosphor screen including phosphor layers;
a second substrate opposed to the first substrate across a gap and provided with a plurality of electron emission sources which excite the phosphor layers;
a plurality of columnar spacers which are arranged between the first substrate and the second substrate and support an atmospheric load acting on the first and second substrates,
the plurality of spacers being individually bonded on the first substrate or the second substrate with an adhesive having an electrical resistance not higher than an electrical resistance of the spacers and set up on one of the substrates.

2. The image display device according to claim 1, wherein the spacers and the adhesive mainly formed of glass.

3. The image display device according to claim 2, wherein the softening point of a glass component of the adhesive is lower than the softening point of a glass component of the spacers.

4. The image display device according to claim 1, wherein the difference between the respective thermal expansion coefficients of the adhesive and the one of the substrates is within ±20%.

5. The image display device according to claim 1, wherein differences in height between the plurality of spacers range from 1 μm to 50 μm.

6. The image display device according to claim 1, wherein the plurality of spacers are fixed directly on an inner surface of the first substrate with the adhesive.

7. The image display device according to claim 1, wherein the plurality of spacers are fixed on a phosphor screen of the first substrate with the adhesive.

8. The image display device according to claim 1, wherein the first substrate has a metal back that is formed overlapping the phosphor screen, and the plurality of spacers are fixed on the metal back with the adhesive.

9. The image display device according to claim 1, wherein each of the spacers has an end face bonded on the one of the substrates with the adhesive and a plurality of grooves formed in the end face.

10. The image display device according to claim 1, wherein each of the spacers is tapered so that the diameter thereof is reduced from one end thereof on the at least one substrate side to the other end.
